(19) United States
(12) Patent Application Publication
(10) Pub. No.: US 2025/0361743 A1
(43) Pub. Date: Nov. 27, 2025

(54) AIR SUPPORT AND AIR RIB COMBINED TENT

(71) Applicant: Yehong Chen, Shantou (CN)

(72) Inventor: Xinjun Yu, Shangyu (CN)

(21) Appl. No.: 19/178,720

(22) Filed: Apr. 14, 2025

(30) Foreign Application Priority Data
Jun. 11, 2024 (CN) 202410744492.9

(51) Int. Cl. E04H 15/20; F16K 1/32

(52) U.S. Cl. CPC E04H 15/20; F16K 1/32; E04H 2015/201; E04H 2015/206

(57) ABSTRACT

An air support and air rib combined tent is provided, including air support tent cloth; an air rib framework formed by connecting a plurality of hollow air ribs to each other, wherein the air support tent cloth wraps around the air rib framework; a built-in air pump assembly arranged in at least one air ribs, wherein the built-in air pump assembly includes a detachable power source, a pump body, and a control switch; deflation valves arranged on the air ribs. The tent is provided with the built air pump assembly, so that the tent does not require an external air pump for inflation. No manual inflation is required, so that the labor is saved, automatic inflation is implemented, and the inflation is quicker. Compared with manual inflation, the air support and air rib combined tent greatly improves the inflation efficiency and saves the inflation time.

### TECHNICAL FIELD

The present disclosure relates to the technical field of tents, and in particular, to an air support and air rib combined tent.

### BACKGROUND

As one of essential equipment for outdoor camping, tents play an increasingly important role in the travel life of people. Therefore, people start to consider the portability of a tent when purchasing the tent.

At present, an inflatable tent is usually inflated by connecting an external air pump to an air nozzle on the tent. If a hand pump or an inflator is used for inflation, the inflation is slow, labor-intensive, and time-consuming. It is inconvenient to use an external electric pump for inflation, and the external electric pump needs to be carried separately and is usually powered by a household alternating current power source. It is often difficult to obtain the household alternating current power source during outdoor camping. As a result, it is inconvenient to inflate the inflatable tent; the inflation efficiency is low; and it is inconvenient to carry an additional inflation device.

### SUMMARY

The present disclosure aims to solve many problems in the prior art. To this end, the present disclosure aims to provide an air support and air rib combined tent. A built-in air pump assembly is arranged inside an air rib of the tent to automatically inflate the air rib. The air rib can be automatically opened after being inflated to form an air rib framework to support tent cloth, thus completing automatic building work of the tent. The air support and air rib combined tent is more convenient and quicker to use.

In order to achieve the above objectives, technical solutions of the present disclosure are as follows:

An air support and air rib combined tent includes air support tent cloth and an air rib framework. The air support tent cloth wraps around the air rib framework. A built-in air pump assembly is arranged inside the air rib framework. The built-in air pump assembly inflates the air rib framework. The built-in air pump assembly includes a main body, a power source arranged inside the main body, a control switch arranged on a surface of the main body, and a pump body arranged inside the main body. The main body is of a cylindrical structure. The main body is provided with a mounting cavity. The power source is detachably mounted in the mounting cavity of the main body.

An air support and air rib combined tent includes air support tent cloth; an air rib framework formed by connecting a plurality of hollow air ribs to each other, wherein the air support tent cloth wraps around the air rib framework; a built-in air pump assembly arranged in at least one air ribs, wherein the built-in air pump assembly includes a detachable power source, a pump body, and a control switch; and deflation valves arranged on the air ribs.

Based on the above solution, further, the built-in air pump assembly includes a main body; the power source and the pump body are arranged inside the main body; the control switch is arranged on a surface of the main body; the main body is of a cylindrical structure, and a mounting cavity is provided in the main body; the power source is detachably mounted in the mounting cavity of the main body; and a plurality of air inlets are provided in the main body.

Based on the above solution, further, configurations of the air rib include:
an outer side layout: the air ribs are exposed out of the tent cloth to improve the wind resistance;
an inner side layout: the air ribs are embedded into a sandwich layer of the tent cloth to maximize an internal space; and
hybrid layout: key nodes use the air ribs outside, and the remaining portions are embedded. In a sandy land environment, the air ribs on the outer side provide additional supports to prevent the tent from collapsing. During household camping, the inner side layout improves the inside comfort level.

Based on the above solution, further, the mounting cavity has a plurality of first conductive sheets arranged on an inner wall of the mounting cavity; the power source includes: a shell that includes a printed circuit board (PCB) and a rechargeable battery; a plurality of second conductive sheets are arranged on an outer wall of the shell; the second conductive sheets are configured to be connected with the first conductive sheets to establish electrical connection; a socket on the PCB is aligned with a charging port on the shell; the PCB is electrically coupled to the rechargeable battery; and the rechargeable battery is further electrically connected to the second conductive sheets; or the power source includes: a solar charging panel and a rechargeable battery connected to the solar charging panel.

Based on the above solution, further, the mounting cavity is provided with several first conductive sheets on an inner wall; the power source includes a case, a PCB arranged inside the case, and a rechargeable battery; several second conductive sheets used in conjunction with the first conductive sheets are arranged on an outer wall of the case; a charging port on the case is opposite to a jack on the PCB; the PCB is electrically connected to the rechargeable battery; and the rechargeable battery is electrically connected to the second conductive sheets.

Based on the above solution, further, the air rib framework is of an X-shaped structure, an H-shaped structure, or an (X+H) hybrid structure and is composed of the plurality of air ribs. The air ribs are of hollow structures, and inner cavities of all the air ribs are communicated to each other. The top compression capability of the H-shaped air rib framework is improved by transverse air ribs, which is applicable to a snow environment or a raining environment. The hybrid structure (X+H) uses a redundant air rib design at the key nodes, which improves the adaptability to a complex terrain. The inner cavities of all the air ribs are communicated to each other by a high frequency welding or heat sealing process. During inflation, an air pressure is uniformly transmitted through the inter-communicated air cavities, thus avoiding local overpressure or non-uniform inflation. Preferably, the plurality of air ribs in the air rib framework include air ribs supported on the ground and transverse air ribs located at a top, to form the H-shaped structure, or the air ribs connect two X-shaped structural air rib frameworks, two H-shaped structural air rib frameworks, or an X-shaped structural air rib framework to an H-shaped structural air rib framework.

Based on the above solution, further, the built-in air pump assembly is arranged in any one of the air ribs, and the remaining air ribs are provided with the deflation valves.

The air support and air rib combined tent further includes a protective cover. The protective cover is located in the air rib and wraps around the built-in air pump assembly.

Based on the above solution, further, several air inlets are provided in the main body. An air outlet of the pump body is communicated to the inner cavities of the air ribs.

Based on the above solution, further, the deflation valve includes a valve body, a valve sleeve, a valve rod, a sealing element, and a first reset member; the valve body and the valve sleeve are both hollow structural members; one end of the valve body is communicated to the inner cavity of the air rib, and the valve sleeve is arranged at another other end of the valve body;

the valve sleeve is provided with a deflation port; the valve rod is arranged inside the valve sleeve and is partially inserted into the deflation port of the valve sleeve; an annular groove is provided in one end of the valve rod; a pressing cap is arranged at another end of the valve rod; the sealing element is sleeved inside the annular groove; the sealing element is in tight fit with the valve sleeve; one end of the first reset member resists against an inner surface of the pressing cap; and another end of the first reset member resists against an inner bottom wall of the valve sleeve.

Based on the above solution, further, the deflation valve further includes a second reset member; a cross structural frame is arranged inside the valve body; a limiting convex column is arranged on the cross structural frame; the valve rod is provided with a limiting concave cavity at an end portion of one end provided with the annular groove; one end of the second reset member sleeves the limiting convex column and resists against the cross structural frame; and another end of the second reset member is located inside the limiting concave cavity and resists against the valve rod.

Based on the above solution, further, at least one entrance curtain and several breathable screen windows are arranged on the air support tent cloth, and the breathable screen windows are arranged on two sides of the air support tent cloth and are close to a top position.

Based on the above solution, further, the air support and air rib combined tent further includes a connector and a canopy; the canopy is connected to the entrance curtain through the connector; the connector includes a mother buckle and a son buckle used in conjunction with the mother buckle; the mother buckle is connected to the entrance curtain; and the son buckle is connected to the canopy.

Based on the above solution, further, a connecting slot is provided inside the mother buckle; several sawtooth grooves are provided in inner top and bottom walls of the mother buckle; the son buckle is a U-shaped elastic structural member; several sawteeth are arranged on an outer surface of the son buckle; and the sawteeth are used in conjunction with the sawtooth grooves.

Based on the above solution, further, a pressing opening is provided in the mother buckle; a pressing portion is arranged on the outer surface of the son buckle; and the pressing opening is aligned with the pressing portion.

The air support and air rib combined tent further includes several plug connectors; the plug connectors are connected to the air support tent cloth; the plug connectors are made of a rigid material and are drill bit-shaped structural members with wide tops and narrow bottoms; blades are arranged on outer surfaces of the plug connectors; and the blades are of spiral structures and are overall of structures having wide tops and narrow bottoms.

Based on the above solution, further, a flexible solar cell panel can be configured, which is connected to the rechargeable battery through a connection port. For example, in a sunny area, the solar cell panel can charge the battery to prolong outdoor use time. During use or transportation, the solar cell panel can be removed for storage, which avoids an increase in a basic weight of the tent.

Compared with the prior art, the present disclosure has the following beneficial effects:

1. The tent of the present disclosure is provided with the built air pump assembly, so that the tent does not require an external air pump for inflation. The built-in air pump assembly automatically inflates the air ribs (the air rib framework). No manual inflation is required, so that the labor is saved, automatic inflation is implemented, and the inflation is quicker. Compared with manual inflation, the air support and air rib combined tent greatly improves the inflation efficiency and saves the inflation time.

2. The built-in air pump assembly of the present disclosure is provided with the detachable power source for detachable charging. The power source provides power for the built-in air pump assembly, without carrying an additional inflator or another inflation device, so that the inflation is more convenient and simpler.

3. The tent of the present disclosure is provided with the deflation valves. The deflation valves can be used to deflate the air ribs (the air rib framework). After deflation, the volume is small, the weight is reduced, and the convenience of storage is significantly improved.

4. The tent of the present disclosure is further provided with the canopy. The canopy is connected to the entrance curtain through the connector, to meet usage needs of different outdoor environments.

The air support and air rib combined tent of the present disclosure is applicable to camping, or can be used as disaster rescue tents and temporary commercial facilities and has quick deployment, structural stability, and extendibility.

### BRIEF DESCRIPTION OF THE DRAWINGS

FIG. 1 is a three-dimensional diagram of a tent according to the present disclosure;

FIG. 2 is a three-dimensional diagram of an air rib framework according to the present disclosure;

FIG. 3 is a three-dimensional diagram of a built-in air pump assembly according to the present disclosure;

FIG. 4 is a cross-sectional view of a built-in air pump assembly according to the present disclosure;

FIG. 5 is a cross-sectional view of a deflation valve according to the present disclosure;

FIG. 6 is a top view of a tent with a canopy according to the present disclosure;

FIG. 7 is an enlarged view of part A in FIG. 6 according to the present disclosure;

FIG. 8 is a cross-sectional view of a connector according to the present disclosure;

FIG. 9 is a front view of a plug connector according to the present disclosure;

FIG. 10 is a three-dimensional diagram of an air rib framework according to another embodiment of the present disclosure; and

FIG. 11 is a top view of the air rib framework in FIG. 10.

In the drawings:
1: air support tent cloth; 101: entrance curtain; 102: breathable screen window;
2: air rib framework; 201: air rib;
3: built-in air pump assembly; 301: main body; 3011: mounting cavity; 3012: first conductive sheet; 302: power source; 3021: case; 3022: PCB; 3023: battery; 3024: second conductive sheet; 303: control switch; 304: pump body; 305: air inlet;
4: deflation valve; 401: valve body; 4011: cross structural frame; 4012: limiting convex column; 402: valve sleeve; 4021: deflation port; 403: valve rod; 4031: annular groove; 4032: pressing cap; 4033: limiting concave cavity; 404: sealing element; 405: first reset member; 406: second reset member;
5: protective cover;
6: canopy;
7: connector; 701: mother buckle; 7011: connecting slot; 7012: sawtooth groove; 7013: pressing opening; 702: son buckle; 7021: sawtooth; 7022: pressing portion;
8: plug connector; and 801: blade.

### DETAILED DESCRIPTION OF THE EMBODIMENTS

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations consistent with the present disclosure. On the contrary, they are only examples of apparatuses consistent with some aspects of the present disclosure as detailed in the attached claims.

The terms used in the present disclosure are for the purpose of describing specific embodiments only and are not intended to limit the present disclosure. Unless otherwise defined, technical or scientific terms used in the present disclosure should have the ordinary meanings as understood by those of ordinary skill in the art to which the present disclosure belongs. The similar term such as “one” or “a/an” in this specification and claims of the present disclosure does not express a quantity limitation, but indicates the existence of at least one. “Plurality” includes two, equivalent to at least two. The similar term such as “include” or “contain” means that an element or object that appears in font of “include” or “including” encompasses those behind “include” or “including” and their equivalents, but do not exclude other elements or objects. The term such as “connect” or “connection” is not limited to physical or mechanical connection, and can include electrical connection, whether direct or indirect. The singular forms of “one” and “the” used in this specification and claims of the present disclosure are also intended to include a plural form, unless the context clearly indicates other meanings. It should also be understood that the term “and/or” used herein includes any or all combinations of one or more related listed items.

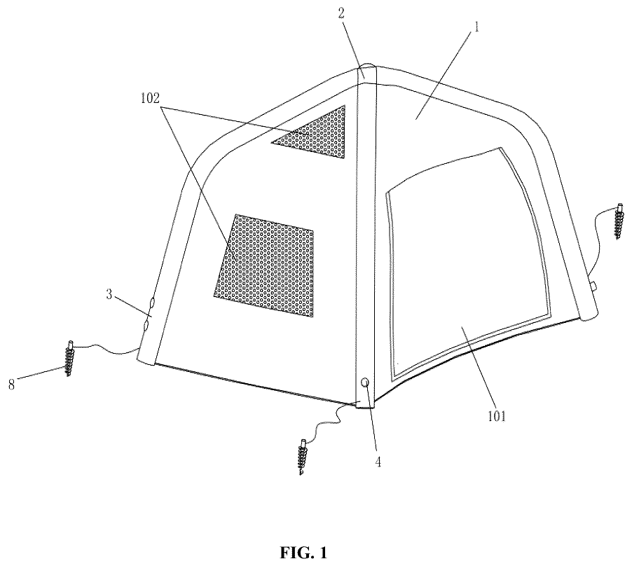

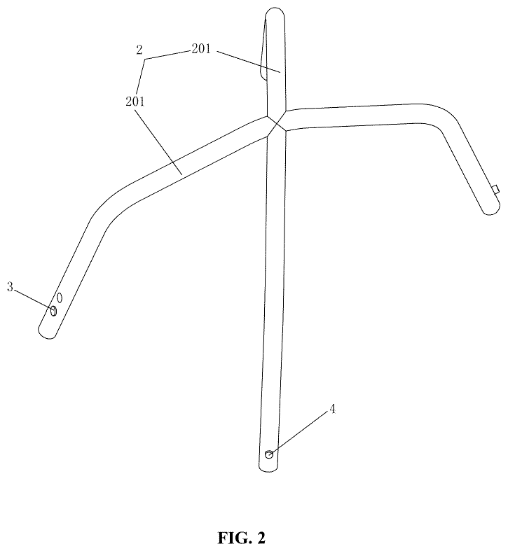

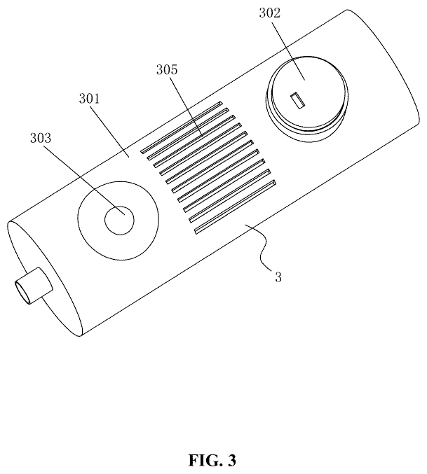

Specifically referring to FIG. 1 to FIG. 4, an air support and air rib combined tent includes air support tent cloth 1 and an air rib framework 2. The air support tent cloth 1 wraps around the air rib framework 2. The air rib framework 2 is of an X-shaped structure composed of a plurality of air ribs 201. Since the air rib framework 2 is configured to be of the X-shaped structure, the tent has good support strength, high stability, and simple structure, and is convenient to store. The air ribs 201 are of hollow structures, and inner cavities of all the air ribs 201 are communicated to each other. A built-in air pump assembly 3 is arranged inside the air rib framework 2. The built-in air pump assembly 3 inflates the air rib framework 2. Specifically, the built-in air pump assembly 3 is arranged in any one of the air ribs 201. The built-in air pump assembly 3 includes a main body 301, a power source 302 arranged inside the main body 301, a control switch 303 arranged on a surface of the main body 301, and a pump body 304 arranged inside the main body 301. The control switch 303 is electrically connected to the pump body 304. The main body 301 is of a cylindrical structure, and a mounting cavity 3011 is provided in the main body 301. The power source 302 is detachably mounted in the mounting cavity 3011 of the main body 301.

This embodiment uses the principle that a built-in inflation pump is used for inflation, which can inflate the air rib framework 2 with one button, so as to support the air support tent cloth 1, which has specific fixing strength and is very convenient to operate. During use, the control switch 303 can be pressed to start the pump body 304 to inflate the air rib framework 2. The power source 302 provides power to the built-in air pump assembly 3. During outdoor use, no external power source will be required. When the power source 302 runs out of battery, the power source 302 can be removed for charging. The power source 302 is compact and lightweight, making it easy to store and carry.

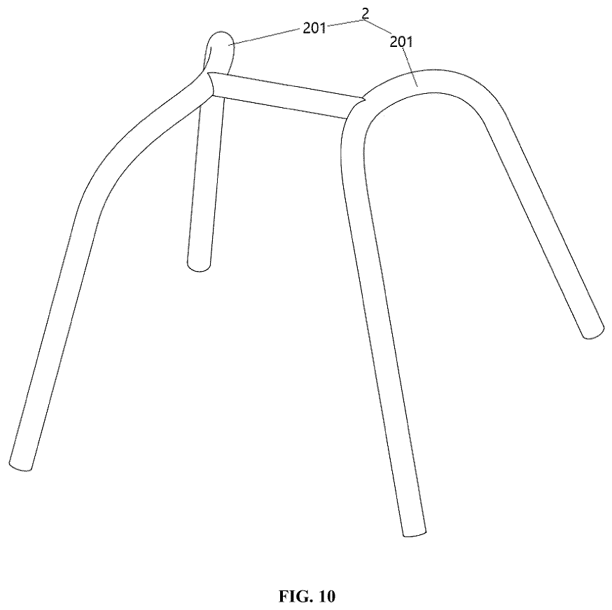

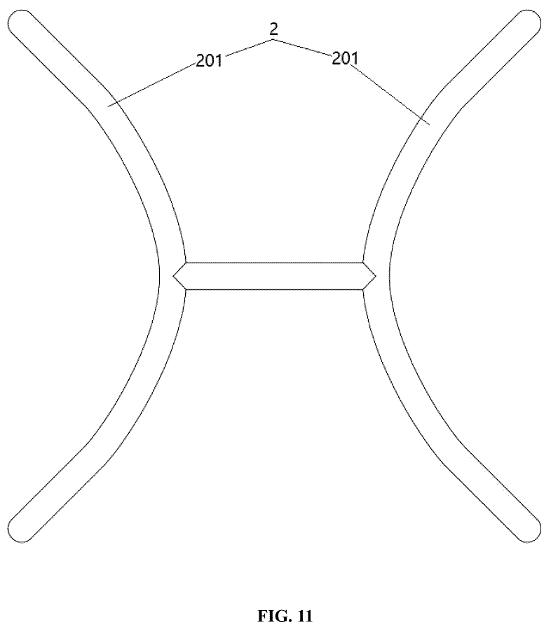

Referring to FIG. 10 and FIG. 11, in another embodiment, the air rib framework 2 is roughly of an H-shaped structure composed of a plurality of air ribs 201. Since the air rib framework 2 is configured to be of the H-shaped structure, a top support space is added while maintaining good support strength and high stability, thereby enlarging an overall accommodating space of the tent.

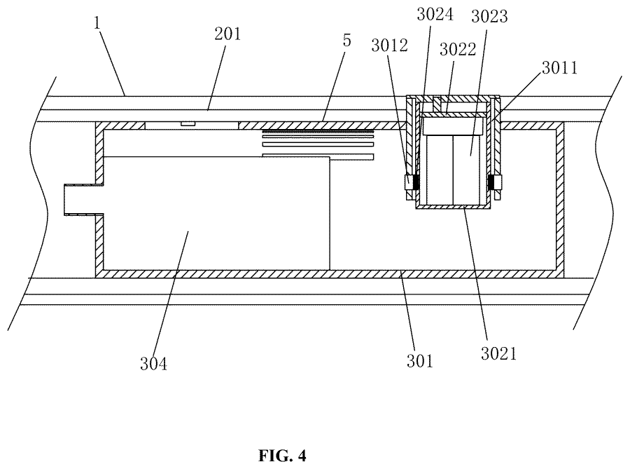

Specifically referring to FIG. 4, further, the mounting cavity 3011 is provided with several first conductive sheets 3012 on an inner wall. The power source 302 includes a case 3021, a PCB 3022 arranged inside the case 3021, and a rechargeable battery 3023. Several second conductive sheets 3024 used in conjunction with the first conductive sheets 3012 are arranged on an outer wall of the case 3021. A charging port on the case 3021 is opposite to a jack on the PCB 3022. The PCB 3022 is electrically connected to the rechargeable battery 3023. The rechargeable battery 3023 is electrically connected to the second conductive sheets 3024. The control switch 303 is electrically connected to the first conductive sheets 3012. The main body 301 is provided with several air inlets 305. An air outlet of the pump body 304 is communicated to the inner cavities of the air ribs 201.

In this embodiment, when the pump body 304 works, air enters the pump body 304 through the air inlets 305, and high-pressure air is output from the air outlet of the pump body 304 and enters the air ribs 201 to inflate the air ribs 201.

Specifically referring to FIG. 4, the air support and air rib combined tent further includes a protective cover 5. The protective cover 5 is located in the air rib 201. The protective cover 5 wraps the built-in air pump assembly 3. The protective cover 5 is partially thermally sealed on an outer surface of the main body 301. An opening is provided in one side of the protective cover 5. The opening communicates the built-in air pump assembly 3 to the air rib 201. Namely, the air support tent cloth 1, the air rib 201, and the protective cover 5 are arranged sequentially from outside to inside. The built-in air pump assembly 3 is hidden inside the protective cover 5, the air rib 201, and the air support tent cloth 1, thus avoiding damage to the built-in air pump assembly 3, effectively prolonging the service life of the built-in air pump assembly 3, and avoiding damage to the built-in air pump assembly 3 caused by an external force.

Preferably, the air rib 201 and the protective cover 5 of this implementation can be made of thermoplastic polyurethane (TPU) or a TPU synthetic material or a polyvinyl chloride (PVC) mesh material. For the air rib 201, the inner cavity is formed through a high-frequency welding or high-temperature heat sealing process, which can maintain long-term air tightness without leakage.

Optionally, a cross section of the air rib 201 is any of a circle, an ellipse, a rectangle, or a polygon.

Optionally, in some feasible embodiments, the air support and air rib combined tent further includes an air pressure detection sensor. The air pressure detection sensor is arranged inside the air rib framework 2. The air pressure detection sensor is electrically connected to the controller. When an air pressure inside the air rib framework 2 detected by the air pressure detection sensor reaches a preset threshold, the tent automatically recognizes a proper pressure value and stops inflation.

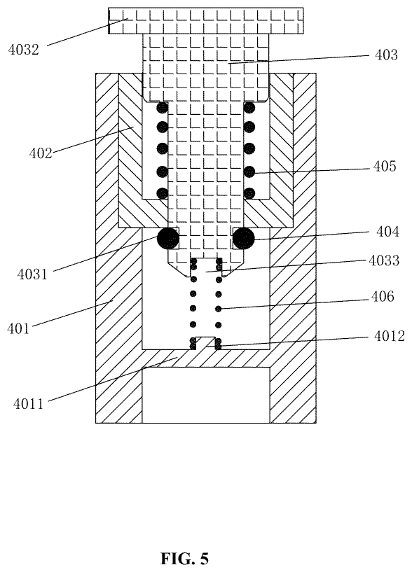

Specifically referring to FIG. 5, in addition to the air rib 201 with the built-in inflation pump, all other air ribs 201 are provided with deflation valves 4. Specifically, the deflation valve 4 includes a valve body 401, a valve sleeve 402, a valve rod 403, a sealing element 404, and a first reset member 405. The valve body 401 and the valve sleeve 402 are both hollow structural members. The valve body 401 is connected to the air rib 201 in a high-temperature heat sealing manner. One end of the valve body 401 is communicated to an inner cavity of the air rib 201, and the valve sleeve 402 is arranged at another other end of the valve body 401. The valve sleeve 402 is provided with a deflation port 4021. The valve rod 403 is arranged inside the valve sleeve 402 and is partially inserted into the deflation port 4021 of the valve sleeve 402. An annular groove 4031 is provided in one end of the valve rod 403. A pressing cap 4032 is arranged at another end of the valve rod 403. The sealing element 404 is sleeved inside the annular groove 4031. The sealing element 404 is in tight fit with the valve sleeve 402 to seal the deflation port 4021 of the valve sleeve 402. One end of the first reset member 405 resists against an inner surface of the pressing cap 4032. Another end of the first reset member 405 resists against an inner bottom wall of the valve sleeve 402.

When not in use, the deflation valves 4 can be used for deflation. After deflation, the volume is small, the weight is reduced, and the convenience of storage is significantly improved. Specifically, to deflate the tent, the pressing cap 4032 on the valve rod 403, and the valve rod 403 moves downwards to compress the first reset member 405. The valve rod 403 drives the sealing element 404 to move downwards. The sealing element 404 moves away from the valve sleeve 402 to open the deflation port 4021, and the air in the air rib 201 leaks out from a gap (the deflation port 4021) between the valve rod 403 and the valve sleeve 402 to achieve a deflation function. A force for pressing the pressing cap 4032 can control a deflation speed. After the deflation is completed, the pressing cap 4032 for deflation is released. Under an elastic force of the first reset member 405, the sealing element 404 can automatically seal the gap (the deflation port 4021) between the valve rod 403 and the valve sleeve 402, to complete sealing.

Specifically referring to FIG. 5, further, the deflation valve 4 further includes a second reset member 406. A cross structural frame 4011 is arranged inside the valve body 401. A limiting convex column 4012 is arranged on the cross structural frame 4011. The valve rod 403 is provided with a limiting concave cavity 4033 at an end portion of one end provided with the annular groove 4031. One end of the second reset member 406 sleeves the limiting convex column 4012 and resists against the cross structural frame 4011. Another end of the second reset member 406 is located inside the limiting concave cavity 4033 and resists against the valve rod 403.

During deflation, the air in the air rib 201 flows out of a gap of the cross structural frame 4011. The second reset member 406 is used in conjunction with the first reset member 405 to enhance the reset effect of the sealing element 404 and improve the sealing performance of the sealing element 404.

Preferably, both the first reset element 405 and the second reset element 406 are springs, and the sealing element 404 is an O-shaped sealing rubber ring.

Specifically referring to FIG. 1, at least one entrance curtain 101 and several breathable screen windows 102 are arranged on the air support tent cloth 1, and the breathable screen windows 102 are arranged on two sides of the air support tent cloth 1 and are close to a top position.

Two sides and a bottom outer edge of the entrance curtain 101 are connected to a notch of the air support tent cloth 1 through a zipper. By the arrangement of the entrance curtain 101, people can quickly enter the tent. By the arrangement of the breathable screen windows 102, a good breathing effect is achieved.

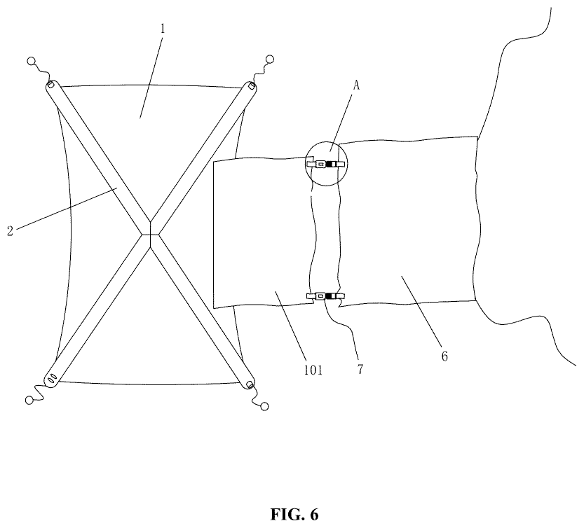

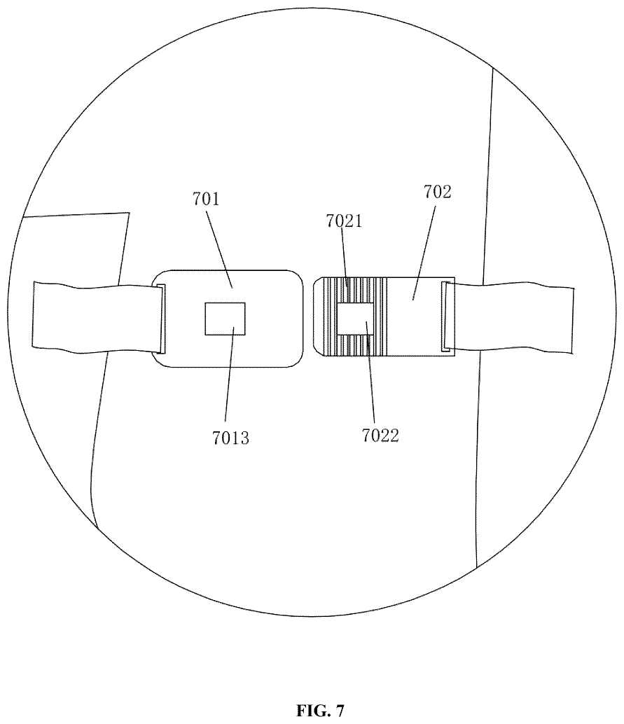

Specifically referring to FIG. 6 and FIG. 7, the air support and air rib combined tent further includes a connector 7 and a canopy 6. The canopy 6 can meet usage needs of various different outdoor environments. The canopy 6 is connected to the entrance curtain 101 through the connector 7. The connector 7 includes a mother buckle 701 and a son buckle 702 used in conjunction with the mother buckle 701. The mother buckle 701 is connected to the entrance curtain 101. The son buckle 702 is connected to the canopy 6. A connecting slot 7011 is provided inside the mother buckle 701. Sawtooth grooves 7012 are provided in inner top and bottom walls of the mother buckle 701. The son buckle 702 is a U-shaped elastic structural member. Sawteeth 7021 are arranged on an outer surface of the son buckle 702. The sawteeth 7021 are used in conjunction with the sawtooth grooves 7012. In this embodiment, the connector 7 is configured to connect the canopy 6, which enlarges a use region of the tent. In other embodiments, the connector 7 can also be connected to another external accessory, such as a fixing member, to enhance a fixed structure of the tent, or a projection screen, to expand a requirement for an outdoor projection scene.

To connect the mother buckle 701 to the son buckle 702, the son buckle 702 can be inserted into the connecting slot 7011 of the mother buckle 701, and the sawteeth 7021 can be clamped into the sawtooth grooves 7012. Through the mutual engagement between the sawteeth 7021 and the sawtooth grooves 7012, a locked and stable connection can be achieved, to prevent falling.

Preferably, several sawteeth 7021 and several sawtooth grooves 7012 are included.

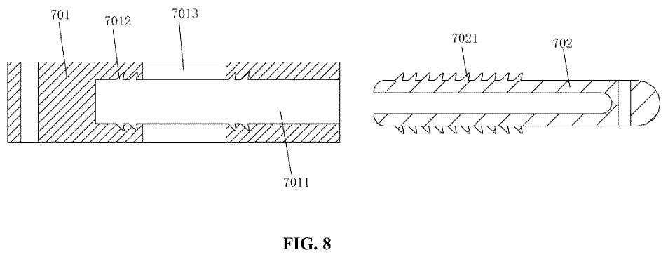

Specifically referring to FIG. 8, further, a pressing opening 7013 is provided in the mother buckle 701. A pressing portion 7022 is arranged on the outer surface of the son buckle 702. The pressing opening 7013 is aligned with the pressing portion 7022. The son buckle 702 can be pressed through the pressing opening 7013, so that the son buckle 702 can enter or leave the connecting slot 7011 of the mother buckle 701, which is convenient to connect and remove the canopy 6.

Preferably, both the mother buckle 701 and the son buckle 702 are integrally formed by using an injection molding process. By integrated molding, the stability of the mother buckle 701 and the son buckle 702 can be effectively improved.

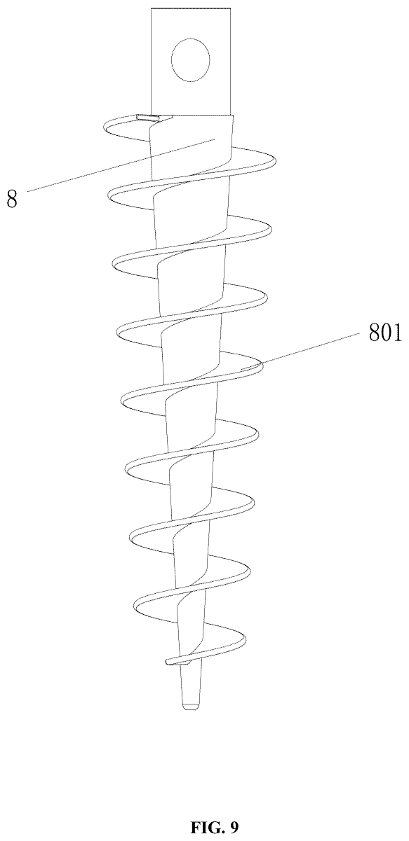

Specifically referring to FIG. 9, the air support and air rib combined tent further includes several plug connectors 8. The plug connectors 8 are connected to the air support tent cloth 1 in a dispersed manner through cord fasteners. One end of each cord fastener is tied to each plug connector 8, and the other end is fastened to the air support tent cloth 1. Fastener rings used in conjunction with the cord fasteners are arranged on the air support tent cloth 1. The plug connectors 8 are made of a rigid material and are drill bit-shaped structural members with wide tops and narrow bottoms. Blades 801 are arranged on outer surfaces of the plug connectors 8. The blades 801 are of spiral structures and are overall of structures having wide tops and narrow bottoms.

The pug connectors 8 can be plugged into soil. Through the plug connectors 8, the tent can be fixed. The blades 801 of the plug connectors 8 are matched with the plug connectors 8 in shape, so that the blades 801 can be smoothly and continuously connected with the plug connectors 8. When the blades 801 rotate the plug connectors 8 downwards, it is easy and convenient to plug the plug connectors into the soil. After being plugged, the plug connectors 8 are not easily pulled out due to a pressure applied from the soil to the blades 801. It is convenient to fix the tent.

The foregoing displays and describes basic principles and main features of the present disclosure and advantages of the present disclosure. Technicians in this industry should understand that the present disclosure is not limited by the embodiments described above. The embodiments described above and the specification only describe the principles of the present disclosure. The present disclosure will also have various changes and improvements without departing from the spirit and scope of the present disclosure, and these changes and improvements shall all fall within the claimed scope of the present disclosure. The protection scope of the present disclosure is defined by the attached claims and their equivalents.

What is claimed is:

1. An air support and air rib combined tent, comprising:
air support tent cloth;
an air rib framework formed by connecting a plurality of hollow air ribs to each other, wherein the air support tent cloth wraps around the air rib framework;
a built-in air pump assembly arranged in at least one air ribs, wherein the built-in air pump assembly comprises a detachable power source, a pump body, and a control switch; and
deflation valves arranged on the air ribs.

2. The air support and air rib combined tent according to claim 1, wherein the built-in air pump assembly further comprises a main body; the power source and the pump body are arranged inside the main body; the control switch is arranged on a surface of the main body; the main body is of a cylindrical structure, and a mounting cavity is provided in the main body; the power source is detachably mounted in the mounting cavity of the main body; and a plurality of air inlets are provided in the main body.

3. The air support and air rib combined tent according to claim 2, wherein the mounting cavity has a plurality of first conductive sheets arranged on an inner wall of the mounting cavity; the power source comprises: a shell that comprises a printed circuit board (PCB) and a rechargeable battery; a plurality of second conductive sheets are arranged on an outer wall of the shell; the second conductive sheets are configured to be connected with the first conductive sheets to establish electrical connection; a socket on the PCB is aligned with a charging port on the shell; the PCB is electrically coupled to the rechargeable battery; and the rechargeable battery is further electrically connected to the second conductive sheets; or the power source comprises: a solar charging panel and a rechargeable battery connected to the solar charging panel.

4. The air support and air rib combined tent according to claim 1, wherein the air rib framework is formed into an X-shaped structure, an H-shaped structure, or an (X+H) hybrid structure by connecting the plurality of air ribs to each other;
the plurality of air ribs in the air rib framework comprise air ribs supported on the ground and transverse air ribs located at a top, to form the H-shaped structure, or the air ribs connect two X-shaped structural air rib frameworks, two H-shaped structural air rib frameworks, or an X-shaped structural air rib framework to an H-shaped structural air rib framework.

5. The air support and air rib combined tent according to claim 1, wherein the built-in air pump assembly is arranged in any one of the air ribs, and the remaining air ribs are provided with the deflation valves; the deflation valve comprises a valve body, a valve sleeve, a valve rod, a sealing element, and a first reset member; the valve body and the valve sleeve are both hollow structural members; one end of the valve body is communicated to an inner cavity of the air rib, and the valve sleeve is arranged at another other end of the valve body; the valve sleeve is provided with a deflation port; the valve rod is arranged inside the valve sleeve and is partially inserted into the deflation port of the valve sleeve; an annular groove is provided in one end of the valve rod; a pressing cap is arranged at another end of the valve rod; the sealing element is sleeved inside the annular groove; the sealing element is in tight fit with the valve sleeve; one end of the first reset member resists against an inner surface of the pressing cap; and another end of the first reset member resists against an inner bottom wall of the valve sleeve.

6. The air support and air rib combined tent according to claim 5, wherein the deflation valve further comprises a second reset member; a cross structural frame is arranged inside the valve body; a limiting convex column is arranged on the cross structural frame; the valve rod is provided with a limiting concave cavity at an end portion of one end provided with the annular groove; one end of the second reset member sleeves the limiting convex column and resists against the cross structural frame; and another end of the second reset member is located inside the limiting concave cavity and resists against the valve rod.

7. The air support and air rib combined tent according to claim 1, wherein at least one entrance curtain and several breathable screen windows are arranged on the air support tent cloth, and the breathable screen windows are arranged on two sides of the air support tent cloth and are close to a top position.

8. The air support and air rib combined tent according to claim 7, further comprising a connector and a canopy, wherein the canopy is connected to the entrance curtain through the connector; the connector comprises a mother buckle and a son buckle used in conjunction with the mother buckle; the mother buckle is connected to the entrance curtain; and the son buckle is connected to the canopy.

9. The air support and air rib combined tent according to claim 8, wherein a connecting slot is provided inside the mother buckle; several sawtooth grooves are provided in inner top and bottom walls of the mother buckle; the son buckle is a U-shaped elastic structural member; several sawteeth are arranged on an outer surface of the son buckle; the sawteeth are used in conjunction with the sawtooth grooves; a pressing opening is provided in the mother buckle; a pressing portion is arranged on the outer surface of the son buckle; and the pressing opening is aligned with the pressing portion.

10. The air support and air rib combined tent according to claim 1, further comprising several plug connectors; the plug connectors are connected to the air support tent cloth; the plug connectors are made of a rigid material and are drill bit-shaped structural members with wide tops and narrow bottoms; blades are arranged on outer surfaces of the plug connectors; and the blades are of spiral structures and are overall of structures having wide tops and narrow bottoms.

11. The air support and air rib combined tent according to claim 1, further comprising a protective cover, wherein the protective cover is located in the air rib and wraps around the built-in air pump assembly.
